(19) United States
(12) Patent Application Publication
(10) Pub. No.: US 2006/0115113 A1
(43) Pub. Date: Jun. 1, 2006

(54) METHOD FOR THE RECOGNITION AND TRACKING OF OBJECTS

(75) Inventors: Ulrich Lages, Hamburg (DE); Volker Willhoeft, Hamburg (DE); Martin Dittmer, Hanstedt (DE)

Correspondence Address: HARNESS, DICKEY & PIERCE, P.L.C., P.O. BOX 828, BLOOMFIELD HILLS, MI, 48303, US

(73) Assignee: IBEO Autobile Sensor GMBH, Hamburg (DE)

(21) Appl. No.: 10/539,661

(22) PCT Filed: Nov. 18, 2003
(86) PCT No.: PCT/EP03/12903

§ 371 Date: Jun. 14, 2005

(51) Int. Cl. G06K 9/00; G06K 9/48

(52) U.S. Cl. 382/103; 382/199

(57) ABSTRACT

The invention relates to a method for detecting and tracking objects based on deep resolution images containing pixels of at least one object, captured over a period of time by at least one sensor for detecting electromagnetic radiation, in particular a laser scanner, in a detection zone of the sensor. According to said method the following steps are carried out in successive cycles: at least one current object outline is formed from the pixels of a current image; at least one object outline is predicted in the current cycle for objects in a preceding cycle, starting from the respective object outline that was assigned to the corresponding object in the previous cycle; and a current position is determined for at least one of the objects, from the current object outline and/or the speed of an object is determined from the current object outline and the object outline in a preceding cycle.

The present invention relates to a method for the recognition and tracking of objects on the basis of images of at least one real object including depth resolved image points detected in time sequence by at least one sensor for electromagnetic radiation, in particular by a laser scanner, with the real object being in a detection range of the sensor.

Methods of the initially named kind are basically known. They can for example be used to monitor a region in front of a motor vehicle which is equipped with a corresponding sensor for electromagnetic radiation. In this way, the movement of objects such as for example other vehicles and stationary objects or pedestrians, moving relative to the motor vehicle can be monitored in a region in front of the motor vehicle, for example, with corresponding alignment of the detection range of the sensor.

For the tracking iterative processes are used in which objects are represented by the position of a reference point of the object. A position of the reference point in a current cycle is predicted from the movement of the reference point in preceding cycles. After segmenting of the current image distances of the segments formed from the predicted position of the reference point are examined. The position of the reference point of the object in the current cycle can then be determined from the coordinates of the image points of the segments associated with an object. Object positions and object speeds can be estimated with reference to the current position and the predicted position.

The tracking of the objects corresponding to the real objects is however made more difficult in that, as a result of the relative movement, real objects in the range of detection of the sensor can enter into the detection region of the sensor in distributed manner over a plurality of detection cycles of the sensor, so that the real object can have different respective extents (sizes) in the images detected by the sensor. In like manner vehicles, for example, can move on a curved path relative to the sensor whereby, for example for elongate real objects, other conditions can result in the determination of the position of the reference point in each cycle. This can lead to undesired effects such as, for example, faulty calculations of speeds and accelerations or loss of object. Furthermore, it can be necessary to deal with complicated methods for a treatment of effects such as an object decay, i.e. the decay of an object into two objects. An object decay of this kind can in particular arise when partial hiding of a real object, which is for example completely detected in preceding cycles, takes place through real objects in the foreground and thus two separate objects apparently arise.

The present invention is thus based on the object of making available a method of the initially named kind which permits an improved recognition and tracking of objects.

The object is satisfied by a method having the features of claim 1.

In the method of the invention for the recognition and tracking of objects on the basis of images of at least one real object including depth resolved image points detected in time sequence by at least one sensor for an electromagnetic radiation, in particular a laser scanner, with the real object being in a detection range of the sensor, the following steps are carried out in sequential cycles: at least one current object contour is formed from image points of a current image, for objects in a preceding cycle at least one object contour is predicted in the current cycle starting in each case from an object contour associated with the respective object in the preceding cycle, for at least one of the objects a current position is determined from the current object contour and/or an object speed is determined from the current object contour and the object contour in a preceding cycle.

A depth resolved image of a sensor for the detection of electromagnetic radiation will be understood to mean a set of image points detected by a scanning of the detection range of the sensor, with points or, depending on the resolution of the sensor, also regions of a real object detected by the sensor corresponding to the image points. The image points thereby include coordinates corresponding to the position of the associated real object points for the definition of a position at least in one plane which does not stand orthogonal to a viewing direction of the sensor. The image points can, furthermore, contain data concerning further characteristics of the real object points, in particular optical characteristics, for example their reflectivity. Depending on the sensor image points can nevertheless be associated with regions of the detection range in which no real objects are present and can then be characterized accordingly.

Sensors for electromagnetic radiation for the detection of such depth resolved images are basically known. These can preferably be optoelectronic sensors which offer a good spatial resolution and thus are preferred for the method the invention. By way of example systems with stereo video cameras can be used which have a means for the conversion of the scan data recorded by the camera into depth resolved images.

However, laser scanners are preferably used which, during a scan, scan a detection region with at least one pulsed beam of radiation which sweeps over a predetermined angular range and detects reflected radiation pulses of the radiation beam, mainly diffusely deflected radiation pulses from a point or region of a real object. In this connection the transit time of the transmitted and reflected radiation pulses are detected for the range measurement. The so detected scan data for an image point can then contain as coordinates the angle at which the reflection was detected and the range of the real object point determined from the transit time of the radiation pulses. The radiation can be visible or infrared light in particular.

The sensors thereby detect the depth resolved images in a time sequence, preferably in an equidistant time sequence, with the image points within a single image not having necessarily to be detected one after the other.

During the conversion of the scan data into image points corrections can also be made, for example with reference to the movement of the sensor, however this is not necessary.

The method of the invention is carried out cyclically with a new current image of the sensor being read into a device suitable for carrying out the method or made available for carrying out the method, preferably for each cycle.

One aspect of the present invention resides in carrying out the object tracking with reference to contours of the real objects which, on the one hand, were at least approximately detected in the depth resolved images from the point of view of the sensor and in any event by corresponding image points and which, on the other hand, are characteristic for many real objects to be tracked, at least for use in road traffic. Thus the contour does not need to be a contour which extends around the article, i.e. a closed line. On the contrary a contour can also only reproduce a part of the outline of the real object which can be detected by the sensor. In the method of the invention object contours associated with the objects are thus used.

First of all a current image of at least one object contour is thus formed from image points. Mainly a plurality of objects will appear.

Furthermore, for objects which were already recognized or tracked in a preceding cycle, at least one object contour likewise associated with the object is predicted in the current cycle, i.e. a predicted object contour, in each case starting from an object contour associated with the respective object in the preceding cycle. During a prediction at least the position of the object contour is predicted, preferably also the shape. Thus an estimated position and/or shape of the object contour results in the current cycle. During the prediction translations and/or rotations of the object contour can for example basically be taken into account, because the position of a contour can include both the position and also the orientation of the contour. This prediction step can fundamentally take place at each stage of the cycle after the determination of object contours in the preceding cycle and of the speeds and/or accelerations in the preceding cycle which may if necessary be used for the prediction, but prior to a further use of the current object contour.

This current object contour can, in particular when detecting the depth resolved image by a laser scanner, be regarded as a very accurate determination of the current position of the object, i.e. of the position and orientation. In particular this actualized contour can thus be used for the definition of the position and optionally also the extent of the object directly after or only after calculation, for example of a geometric centre of gravity of the object contour.

A current position of the object can now be determined from the current object contour and/or an object speed can be determined from the current object contour and the object contour in the preceding cycle, in particular from its positions. In this respect the position of the object contour in the preceding cycle can naturally also be taken indirectly into account, for example by using the object contour predicted from it. Furthermore, during the speed determination, the time spacing of sequential image detections can be used, which is preferably constant but which does not necessarily have to be constant.

The position and/or speed of the object can then be stored for further use or can be output to a further means processing the data.

Naturally, depending on the images that are processed, it can transpire with the method of the invention that in an individual case only a single object is tracked.

The method of the invention is thus not based on the use of an overall centre of gravity of the object, so that apparent shifts of the overall centre of gravity through a change of the object contour or of the positions of the corresponding image points does not lead to errors. In particular a rotation of an object or a yawing movement of a real object can be automatically taken into account, which in particular can substantially simplify and improve the association of image points to objects.

Moreover, objects, which are only partly visible in an image in a given cycle, can simply be followed further, with the contour if necessary being correspondingly enlarged or, on leaving the detection region, being also correspondingly reduced. Since corners and/or edges of real objects can, for example, be tracked with the contour, errors in the object tracking are more easily avoided with the method of the invention in such situations.

Further developments and preferred embodiments of the invention are described in the claims, in the description and in the drawings.

When a plurality of objects appear, current object contours could in particular correspond to different predicted object contours. It is thus preferred for a current object contour to be associated with one of the predicted object contours or object contours in a predetermined cycle, for which purpose a preset association criterion can be used. In this connection the case can arise that no current object contour can be associated with a predicted object contour, for example when the corresponding real object was completely hidden by objects in the foreground. Furthermore, the case can arise, that no real object is detected in the detection region by the sensor. A new formation of a current object contour can then not take place. It is preferred, when no current object contour can be associated with a predicted object contour, for the predicted object contour and/or the object contour from a preceding cycle to be used further and for the corresponding object is preserved. The predicted object contour can thus be used to output a position and/or speed of a corresponding object. Accordingly corresponding data can if necessary also be output without the real object having been detected in the current cycle. Furthermore, a prediction of a newly predicted object contour and a new association of a current object contour are possible, if required, in one of the following cycles.

In a particularly preferred manner an object corresponding to an object contour of this kind does not have to be tracked further when the uncertainty of the prediction is too large. The uncertainty can result in particular from the number of sequential cycles during which no corresponding current object contour was found, or from an estimated error of the prediction.

In the method of the invention current object contours can basically be formed in any desired manner, in particular directly from image points of the current image. In order to facilitate an association it is however preferred for segments to be formed for the formation of current object contours from image points of a current image, in that a segment contour associated with the segment and its position are determined for each of the segments, in that one of the segment contours is compared with at least one of the predicted object contours with reference to the position and/or the shape and, in dependence of the result of the comparison, the segment corresponding to the segment contour is associated with one of the objects and in that current object contours are respectively formed from the segments respectively associated with the segment contours of objects.

Segments are formed first of all from image points of a current image. In a segmenting of this kind segments can in particular be formed from image points of the image with the segments respectively corresponding to an individual image point or to a set of all image points of which, in each case, at least two can be defined as belonging to the segment in accordance with at least one segmenting criterion and which among one another have no common image points. This segmenting criterion can in particular be a criterion for a maximum permissible spacing and/or a maximum permissible difference of an optical characteristic, and in particular of the reflectivity. Furthermore, when using a laser scanner an inclination of a surface determined from the pulse width and/or pulse heights can also be used. Methods for segmenting are basically known and thus do not need to be described in more detail in the following.

For each of the segments that are formed a segment contour associated with this segment and its position are then determined and for a segment consisting only of one image point the contour can also consist of only one image point. The segment contour and its position are thereby determined on the basis of the image points associated with the segment and in particular the position coordinates of the image points.

In the following step an association of segments of the current cycle to predicted objects is essentially effected. For this purpose one of the segment contours, preferably each segment contour is compared with at least one of the predicted object contours with respect to position and/or shape. In dependence on the result of the comparison the segment corresponding to the segment contour is then if necessary associated with one of the objects considered. During the comparison an attempt is made to determine whether the segment contour could correspond at least in part to an object contour from the point of view of shape and/or position. If an adequate correspondence is found, the segment is associated with the corresponding object, otherwise the segment is associated with another suitable object. If no other object is found then a new object is if necessary produced from the segment.

After this step all segments are preferably associated with objects and current object contours are formed for all objects from the segment contours of the segments associated with the respective objects.

The use of segments permits a simple and rapid association of image points to objects and also a simple and rapid formation of object contours. In this connection a rotation of an object or a yawing movement of an object can automatically be taken into account through the object tracking of the basis of object contours and this can in particular substantially simplify and improve the segment/object association.

The contour used in the method does not need to correspond to the current outline of the real object corresponding to the (virtual) object. On the contrary, if the real object is partly hidden the resolution of the sensor or the inaccuracy of the method can lead to differences between these two contours. The contour of a segment or also of an object can basically be defined in any manner. It is in particular possible to describe the contour by a function determined by parameters, with non local descriptions in particular being possible with orthogonal function systems, for example Fourier series or wavelets. The contour thereby preferably extends at least approximately through the image points of the segment or of the object. For a simplified handling of the contours in the method it is preferred for the contours to be defined by a contour element or a series of contour elements and for the contour element or the data defining the contour elements to be found from at least one image point of a segment or from contour elements of a different contour. The term “series” thereby in particular also includes the contour elements having a predetermined sequence. The contour in the sense of the method is thus only defined by the contour elements. If necessary lines can be computed from the contour elements which illustrate a contour, however this is not absolutely necessary. The handling of contours can in this case be reduced to the handling of contour elements, which can substantially simplify the method of the invention. A contour element is in this connection defined by data which relate to characteristics having regard to the contour. These data can be determined, in particular with segment contours, from at least one image point of a segment or, in particular for object contours, from contour elements of one or more other contours. In particular object contours can be formed by taking over contour elements from one segment or by taking over contour elements from a plurality of segments and, if necessary, a change of the sequence.

The data defining the contour elements can fundamentally be any desired data for the definition of a contour corresponding to the position of the image points. In this connection it is preferred for the contour elements to each include position coordinates as data. These can in particular be determined from one or more image points of a segment with which the contour and thus also the contour element is associated. In such a case the contour elements can be at least partly regarded as contour points which, connected by corresponding lines, approximately reproduce an outline given by the image points of the segment or of the object. A contour element can however also include further data. Contour elements of a segment contour can be formed in different ways and means. In this connection all contour elements must not necessarily be determined with precisely the same method.

Thus it is preferred that, for the formation of a contour element of a segment contour, a predetermined number of sequential image points of the segment with polar angles which increase or reduce in a series with respect to a predetermined polar axis are associated with a corresponding contour element and that data of the contour element is determined from the image point.

The polar axis can in this connection, be essentially any desired axis which however lies in the image plane in which position coordinates of the contour element are defined. A coordinate axis of a coordinate system is preferably used in which the coordinates of the image points are also defined. In this manner groups of image points of a segment are, to some extent, collected together and associated with contour elements, with data of the contour element, in particular for example its position coordinates being obtained from the image points, for example by a simple averaging. The groups of image points formed thereby can fundamentally have common image points, however it is preferred for them not to have any common image points. In this case segments can naturally arise which have a number of image points which is not a multiple of this preset number. In this case the contour element is formed from the remaining image points in otherwise the same manner as the other contour elements of the segment contour. The predetermined number can in particular be selected in dependence on the resolution capability of the sensor and the length scales on which contours of real objects to be tracked typically change their direction when using the method. Furthermore, the speed of execution with which the method is to be carried out can be taken into account.

In another alternative it is preferred, for the formation of a contour element of a segment contour, for respectively sequential image points of the segment in a series of increasing or decreasing polar angles with respect to a predetermined polar axis to be associated with a corresponding contour element, the spacing of which from a first image point associated with the contour element is smaller than a predetermined maximum spacing and for data of the contour element to be determined from these image points. The polar axis and the polar angles are definable as in the previously indicated alternative. In this alternative contour elements are formed which have a similar spacing from one another. The determination of the data of the contour element from the image points can in turn take place as for the alternative indicated above.

In a further alternative it is preferred for a regression line to be placed through the image points of a segment and for contour elements to be determined in that position coordinates for contour elements are determined at equal intervals on this regression line. In this method a uniform distribution of the contour elements results along an outline of the segment.

Furthermore, it is preferred for contour elements to be obtained by vectorizing a curve which arises by connection of the image points of a segment in a sequence of increasing or decreasing polar angles with respect to a predetermined polar axis. In this manner a particularly small number of contour elements is generated which are defined only at particular characteristic curves of an outline, namely in particular at kinks or corners of the line. Methods for the vectorization of such curves are fundamentally known. In order to avoid the formation of contour elements with only small deviations of image points from a straight line a regression line can in particular be placed through the image points as a curve.

The positions of the image points of a segment can, as a result of measurement error of a sensor, or also as a result of movements of a real object in a direction perpendicular to the detection region, as well as a result of a possibly very irregular surface of the object have considerable errors or scatter considerably under certain circumstances. These deviations are however unimportant for the functioning of the method. It is thus preferred for the positions of the image points of a segment to be subjected to a low pass filtering operation prior to the formation of the contour elements. In this, sliding mean values can for example be formed.

The number of contour elements of a segment contour can basically be larger than the number of the image points of the segment. However, in this way, the complexity in handling the contours is increased. It is thus preferred for the number of contour elements of the segment contour to be not larger than the number of image points of the segment contour. A smaller number of contour elements is particularly preferably used since in this way it is not only possible to reduce the processing complexity but rather also an averaging can take place in the determination of the data of a contour element via the image points used for the formation of the contour element, so that random fluctuations in the data of the contour element can be reduced.

Depending on the real object which is detected a contour of the real object can be smooth, for example of a wall, or also very irregular or disrupted, for example with a bush. If a contour element is formed from a plurality of image points then it is preferred for a quality to be associated with at least one contour element which depends on the positions of the image points used for the determination of the contour element. This quality can in particular be a measure for the extent to which a characteristic of the contour element described by the data of the contour element differs from the corresponding characteristic of the image points, i.e. of how significant data relating to a characteristic of contour elements are. Thus, the quality can for example depend on the number of image points used for the formation of the contour element or also from a deviation average, for example a squared deviation of a corresponding characteristic of the image points from the characteristic of the contour element. In particular the mean square spacing of the image points used for the formation of a contour element can for example also depend on a regression line through the image points which leads to the position coordinates of the contour elements. Thus, for example, a wall can be uniformly detected whereas a bush located in front of the wall has a very irregular contour with an unusually high statistical noise. If the contour elements contain corresponding data then these can be taken into account in the association of contour elements.

In the method of the invention the segments are associated through a comparison of the segment contour with a predicted object contour. In this connection it is preferred if an object speed determined in the preceding cycle is used for the prediction of the position of an object contour in a current cycle. This object speed can in particular be a translation speed of the object and/or a rotation speed of the object (yawing speed).

The prediction can in this connection take place with any desired suitable methods. In particular a Kalman filter can for example be used by means of which data, in particular position coordinates of the contour elements, can be predicted. If the object contour is defined by contour elements which contain position coordinates, then the position of the object contour can take place by a shift of the position coordinates of the contour elements which can result through multiplication of the object speed with the time interval between the sequential scans of the detection region. Accelerations are particularly preferably also used, providing these can be determined with adequate accuracy. In this manner a very good and accurate prediction of the object contour results, in particular with a high detection frequency, which simplifies the subsequent segment/object association or the determination of a shift of the current object contour relative to an object contour in a preceding cycle.

In the segment/object association each segment contour can basically be compared each predicted object contour. In this manner an extremely high processing effort however results. It is thus preferred for a capture range to be associated with each object and for a segment contour of a segment to only be compared with an object contour of an object in whose capture range at least one reference point of the respective segment lies. This reference point can in particular be an image point and/or position coordinates of at least one contour element of the segment contour. In this manner the processing effort can be substantially reduced. The size of the capture range can in particular depend on a maximum possible speed of movement of real objects which may possibly occur in the detection region and on the scanning frequency of the sensor that is used.

In this connection it is particularly preferred for objects to be classified in the method in accordance with the invention and for the capture ranges to be defined in dependence in the classes with which the object is associated. For example object classes for pedestrians, two wheeled vehicles, motor cars and trucks can be made available for which the search ranges can be distinguished on the one hand by their shape and on the other hand by their size. For example a search range for a pedestrian can essentially be circular but have only a small diameter, because pedestrians can admittedly move in all directions but only with low speed. A truck is in contrast not very maneuverable so that a search range extended along essentially the direction of the object speed can be used.

In the comparison of a segment contour with an object contour the case can arise that a segment contour could be associated with two different object contours and thus the segment could be associated with two different objects, but that only one association is permissible. It is then preferred for an association quality to be determined for the comparison of a sequent contour with an object contour for a segment and an object, the association quality being a measure for the correspondence of the respective contours with respect to the position and/or shape and for a segment which can be associated with two objects to be associated with that object with which it has the best value for the association quality. In this manner a unique association of segments to objects is possible.

In this connection it is particularly preferred for differences between corresponding data of the contour elements to be found from pairs respectively consisting of a contour element of the segment contour and a contour element of the object contour and for the association quality to be determined using the differences. In this connection only one item of data of the contour element, for example with respect to a characteristic needs to be used. In particular differences in the position coordinates of the contour elements can be used. An association quality can thus be calculated very simply, solely via the contour elements.

It is basically also possible to consider all possible pairs of contour elements of the segment contour and contour elements of the object contour and for example to use the smallest pair spacing or to determine the sum of the square spacings over all the pairs. This however signifies a considerable effort. It is thus preferred for pairs each consisting of a contour element of the segment contour and a contour element of the object contour to be determined among the contour elements of the segment contour and the contour elements of the object contour which are then distinguished in at least one item of the data by at most a predetermined amount and for a number of these pairs to be determined for the determination of the association quality. In this connection all possible pairs are preferably examined. The association quality however only needs to depend on the number of pairs, it can however in particular also be codetermined by further parameters. In particular it is preferred for pairs each consisting of a contour element of a segment contour and a contour element of the object contour to be determined among the contour elements of the segment contour and the contour elements of the object contour for which the position coordinates have a spacing which is smaller than a predetermined maximum pair spacing and for the number of these pairs to be determined for the determination of the association quality. The maximum pair spacing can in particular be selected in dependence on the expected maximum shifts for the duration between two sequential scans of the sensor.

Furthermore, it is preferred for a contour element of the segment contour and a contour element of the object contour to be determined for the determination of the association quality for which the position coordinates among all pairs of contour elements of the sequent contour and contour elements of the object contour have the smallest spacing.

The association quality can in particular also be determined in dependence on a plurality of the above-named parameters. In this way different typical association situations can be taken into account extremely well.

In the segment/object association the case can arise that two segments are associated with one object in accordance with the association quality. However, an association of this kind need not currently be correct, for example two real objects which were treated in one cycle as one object could move apart so that a larger contour would result but an association of two objects would be more correct. In order to be able to better deal with this case of an object decay it is preferred for two or more segments to only be associated with an object when a distance of the segments from the object is in each case smaller than a predetermined maximum spacing. This maximum spacing can in particular be preset in dependence on typical object sizes of a maximum to be expected, which depend on the situation of the application. The spacing can in particular be the minimum spacing which can be computed on the basis of the contour elements of the corresponding contours.

Furthermore, it is preferred to carry out a hiding recognition, during the association of segments to objects. Through a hiding recognition a determination can be made with greater security whether two segments which are to be associated with one object could have arisen by partial covering over of the corresponding real object, so that it is possible to recognize more simply whether the two segments should be associated with one object or whether currently an object decay is present corresponding to the real circumstances.

Furthermore it is preferred that in the recognition of at least two segments which can be associated with the same object, but which should not both be associated with the same object, to associate the segment with the better association quality with the object. The other segment can then preferably be used for the formation of a new object. In this manner an unambiguous criterion for the association of the segments to objects results in the case of an object decay.

A particularly simple determination results when that segment is associated with the object which has the most contour elements.

For the determination of the object speed it is preferred that a difference is determined between the position and/or the orientation of the current object contour and the position and/or orientation of the object contour in the preceding cycle or of the predicted object contour.

Since the total object contour, not just one point, is used for the speed determination it is possible, depending on whether only the position and also the orientation is determined, to determine pure translation speeds or also yawing speeds of the object simply in this way. For a yawing movement the axis of rotation can be defined with reference to the object contour in the preceding cycle, with reference to the object contour in the current cycle or with reference to a further object contour calculated from these object contours. Furthermore, the time spacing of the determinations of the corresponding mutually sequential images can enter into the object speed.

In this connection it is in particular preferred that in the determination of the difference between the position and/or orientation of the object in the current cycle and the position and/or orientation of the object contour in the preceding cycle or of the predicted object contour contour elements of the current object contour and contour elements of the object contour in the preceding cycle or in the predicted contour are associated with one another and that the change of the position and/or orientation of the object contour in the preceding cycle to that in the current cycle is determined from those contour elements of the current contour which were associated with contour elements of the object contour in the preceding cycle or in the predicted object contour.

This signifies that, for the determination of the object movement, only those contour elements are used which appear both in the object contour in the preceding cycle and/or in the predicted object contour as well as correspondingly in the object contour in the current cycle and are associated with one another. Non-associated contour elements are not taken into account so that corresponding influences on the speed of determination are precluded, whereby the accuracy can be increased.

The association preferably takes place taking account of the sequence of the contour elements in the object contours.

Furthermore, it is preferred that for the association of contour elements of two object contours to one another, starting from contour elements of the object contours with position coordinates which respectively correspond to one end of the contour, a search is in each case made for sequential contour elements along one of the two contours, for a not yet associated contour element of the other contour of which the position coordinates have a minimum spacing from the position coordinates of the contour element of the one contour. An association of this kind can take place particularly quickly with a double association of contour elements being avoided which should in principle be avoided.

If accelerations or rotations arise during the object movement or during the movement of the corresponding real object then, depending on the nature of the prediction, the predicted position and optionally also the shape of the object contour can differ from the current position and/or shape of the current object contour. In the association this can lead to faulty associations or make corresponding complicated association algorithms necessary.

It is thus preferred for at least one reference element to be determined in each case for an object contour, for a correction shift between the reference elements of the predicted contour and the current contour to be determined for the association of object elements of the predicted object contour to object elements of the current object contour and for the association of contour elements of the predicted contour to contour elements of the current contour to take place using the contour elements of the predicted contour shifted by the correction shift of the reference elements. These reference elements can in particular be special contour elements, for example the first and the last contour element of a contour. It is, however, also possible to use other special contour elements of an object contour, for example a contour element arranged at a corner of the object contour. In this manner, inaccuracies which occur in the association due to deviations between the predicted object contour and the current object contour can be greatly reduced.

Two reference elements are particularly preferably used and both a correction shift and also a correction rotation of the predicted object contour determined from the shifts of the two reference elements. In this manner, difficulties in the association of contour elements caused by rotations or yawing movements of the object contour or of the real object are reduced.

The determination of the object movement can basically take place using a Kalman filter for the contour elements, in particular for their position coordinates and the associated speeds. It is, however, preferred that differences between the position coordinates of mutually associated contour elements of the current contour and of the contour in the preceding cycle or of the predicted contour are first determined and that a translation and/or a rotation of the object between the preceding cycle and the current cycle is/are determined from these differences and that the object speed is determined on the basis of this translation and/or rotation.

In this way an average value formation is possible which permits a particularly accurate determination of the translation or rotation of the object. The translation can in particular for example be calculated as an average value over the shifts of the contour elements of the object contour in the current cycle relative to the object contour in the preceding cycle. Depending on whether the translation and/or the rotation are determined the object speed can be a translation speed and/or yawing speed.

Furthermore it is preferred that the object speeds are subjected to a low pass filtering operation. In this connection, a one-dimensional Kalman filter can in particular be used for each component of the object speed separately. In this manner statistical errors can be suppressed.

A computer program with program code means in order to carry out the method of the invention, when the program is executed on a computer, is a further subject of the method of the invention. The term “computer” will be understood to include any data processing system which in particular has a processor, a memory and interfaces for the supply or outputting of data. In particular the computer can have a digital signal processor.

Furthermore, the subject of the present invention is a computer program product with program code means which are stored on a computer readable data carrier in order to carry out the method of the invention, when the computer program product is executed on a computer. The data carrier can in particular be a non-volatile memory in the form of corresponding semiconductor components, CDs, DVDs or floppy disks.

Finally, the subject of the present invention is an apparatus for the recognition and tracking of objects with at least one optoelectronic sensor, in particular a laser scanner, the viewing range of which includes the detection range and a data processing device associated with the optoelectronic sensor which is designed to carry out the method in accordance with the invention. This data processing device can in particular be a segment formation unit for the forming of segments of image points of a current image, a segment contour formation unit for the determination of a segment contour and its position from image points of the segment, a prediction unit for the prediction of the position of an object contour in the current cycle from the object contour in a preceding cycle, a segment object association means for the comparison of the segment contours with at least one of the predicted object contours with respect to the position and/or shape and association of a segment to one of the objects in accordance with the result of the comparison, an object contour forming unit for the formation of the current object contour from the segment contours of segments which are respectively associated with the objects and a means for determining a current position and/or an object speed from the current object contour or from the position of the current object contour and the position of the object contour in the preceding cycle for at least one of the objects.

The method in accordance with the invention is particularly suitable for use in monitoring a region in front of a vehicle which is equipped with the apparatus in accordance with the invention.

The invention will now be explained by way of example further with reference to the drawings. There are shown:

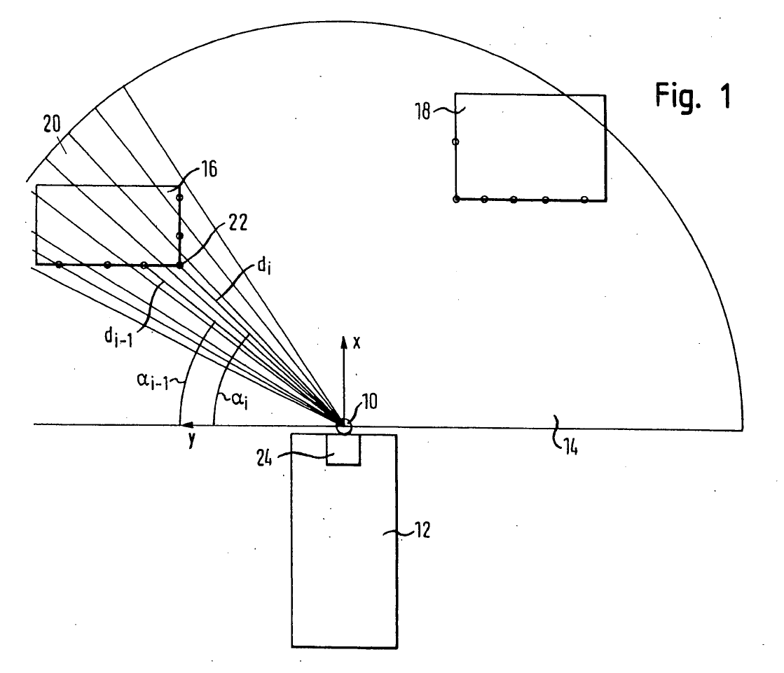

FIG. 1 a schematic plan view of the apparatus of the invention for the recognition and tracking of objects,

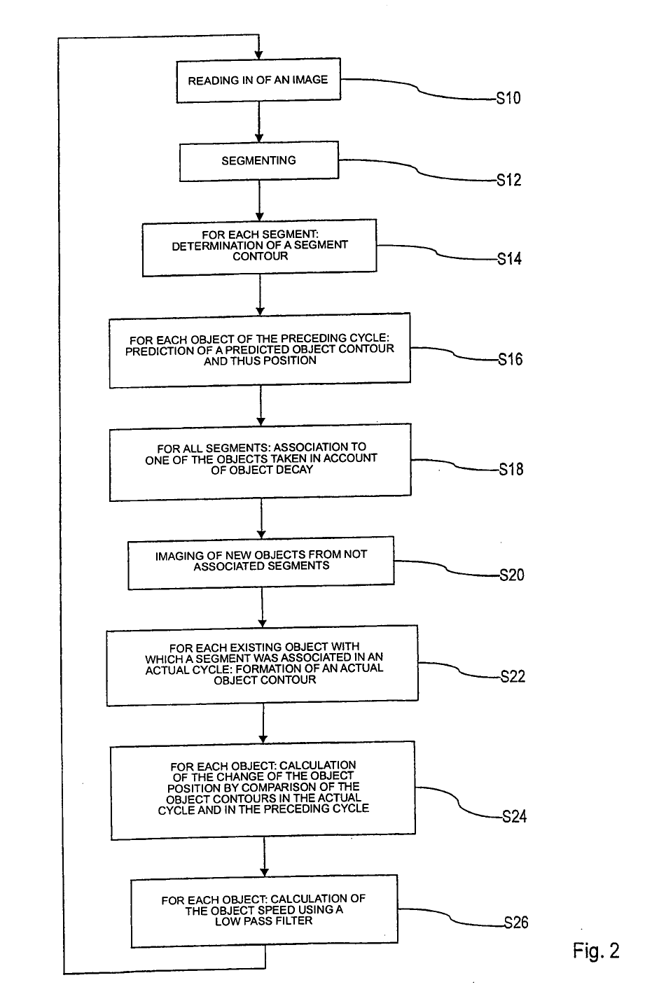

FIG. 2 a schematic flow diagram of a method for the recognition and tracking of objects in accordance with a preferred embodiment of the invention,

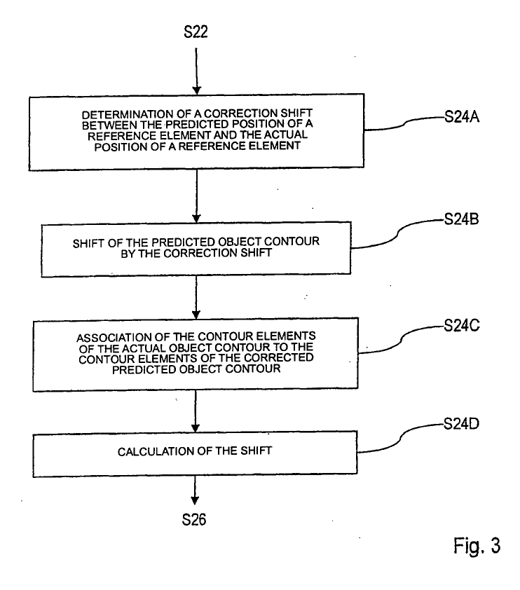

FIG. 3 a schematic flow diagram of part steps of a method step S24 in the flow diagram in FIG. 2,

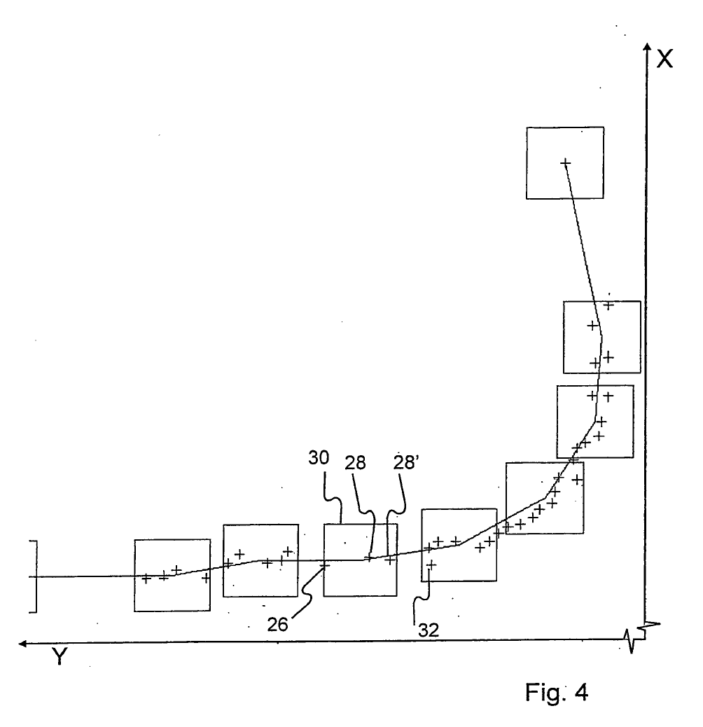

FIG. 4 a schematic representation of image points of a segment and of contour elements in one plane,

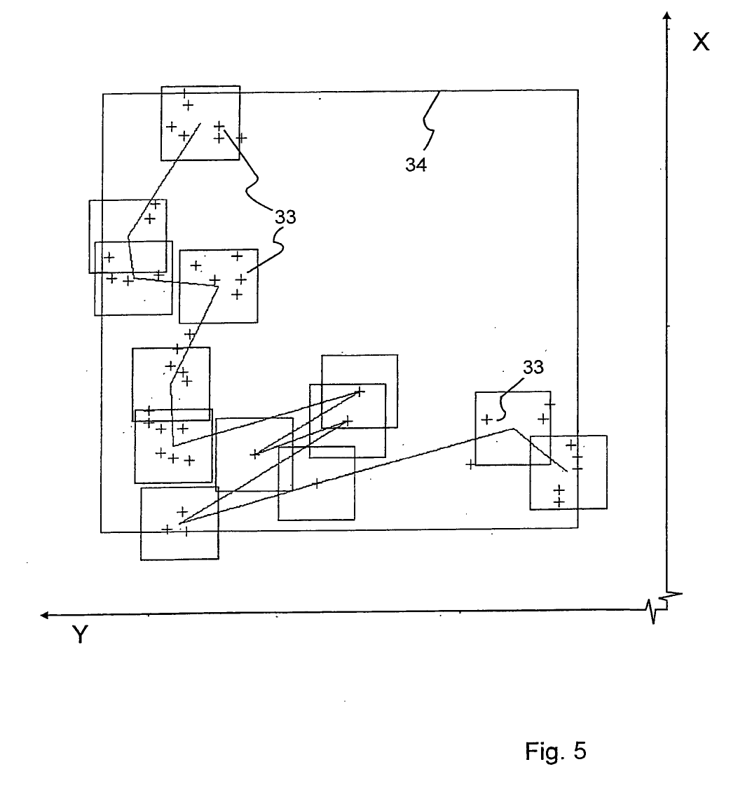

FIG. 5 a schematic representation of image points and contour elements for an object with disrupted surface, and

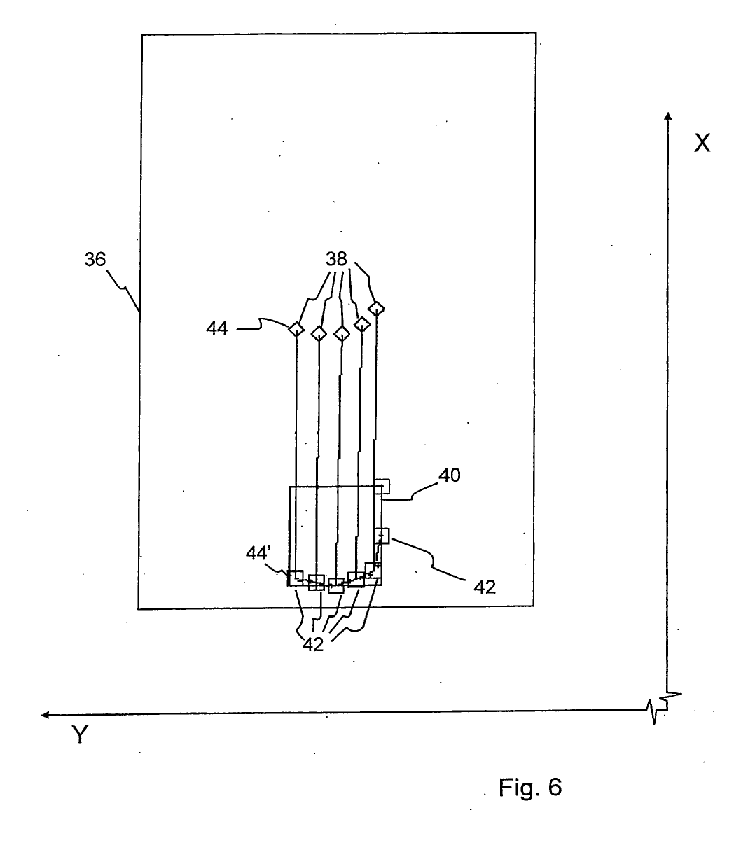

FIG. 6 a schematic representation of a predicted object contour and a current object contour and also an association of contour elements of these object contours to one another.

In FIG. 1 a laser scanner 10 is held at the front side of the motor vehicle 12 in order to detect real objects in front of the motor vehicle 12.

The laser scanner 10 has a detection region 14 which is only partly shown in FIG. 1 and which, as a result of the in-built position, covers an angle of approximately 180° symmetrically to the longitudinal axis of the motor vehicle 12. The detection region is only schematically shown in FIG. 1 and is in particular shown too small in the radial direction for the sake of better illustration. In the detection region 14 there are located, by way of example, two vehicles 16 and 18 as real objects to be detected.

The laser scanner 10 scans its range of view 14 in basically known manner with a pulsed laser beam 20 which rotates with a constant angular speed, with detection likewise being continuously carried out at constant time intervals Δt at times τᵢ in fixed angular ranges around the centre angle αᵢ of whether the laser beam is reflected from a point or region of a real object. The index i thereby extends from one to the number of the angular ranges in the detection region. Only individual ones of these angular ranges are shown in FIG. 1, amongst other things the angular ranges associated with the average angles αᵢ₋₁ and αᵢ. In this connection the angular ranges are shown exaggeratedly large for the sake of a clear illustration. The sensor spacing dᵢ of the real object point from the laser scanner 10 is determined on the basis of the transit time of the laser beam pulse. The laser scanner 10 thus detects, as coordinates in a scan data element for one real object point 22 of the motor vehicle 16, the angle αᵢ and the distance dᵢ determined for this angle, that is to say the position of the real object point 22 in polar coordinates. With a scanning of the visible range the laser scanner thus makes available scan data elements with coordinates (αᵢ, dᵢ), with i representing a natural number between 1 and the number of scan data elements detected by the laser scanner 10.

The quantity of the scan data elements detected during a scan forms, optionally after correction of the data and/or transformation into another coordinate system, a depth resolved image in the sense of the present invention.

The laser scanner 10 respectively scans its visible range 14 in sequential scans so that a time sequence of scans and thus of depth resolved images arises.

For the processing of the scan data elements the laser scanner has an electronic evaluation system or a data processing device 24 which is arranged in the example in the laser scanner, but which can also basically be arranged spaced from it. The data processing device 24 has, amongst other things, a digital signal processor programmed to carry out the method of the invention, a memory device connected to the digital signal processor and also interfaces for the outputting of data to a vehicle control.

The method in accordance with a preferred embodiment of the invention is schematically shown in FIG. 2. The laser scanner 10 detects, as already mentioned, images of its detection region at constant time intervals Δt. The image points of the images can be corrected from the corresponding scan data elements by a corresponding coordinate transformation and optionally further corrections, for example with respect to an own movement of the laser scanner 10. The method of the invention is carried out cyclically, with one cycle being carried out for each newly detected image.

In the step S10 a current image is read in from the laser scanner 10 and includes image points with position coordinates in a Cartesian coordinate system with an X-axis and a Y-axis orthogonal thereto. In the embodiment the X-axis is arranged parallel to the longitudinal axis of the motor vehicle 12, the coordinate system is thus defined relative to the motor vehicle 12.

In the following step S12 the current image is segmented. For this purpose all image points are associated with segments, with one image point being associated with only one segment. For this purpose, for the formation of a new segment, an image point not yet associated with a segment is first associated with the new segment. Then, in the following steps, image points not yet associated with a segment are sought iteratively for each image point of the segment which have a distance from the corresponding image point of the segment which is smaller than a predetermined segmenting distance selected for example in dependence on a resolution capability of the laser scanner 10. If an image point of this kind is found which is not associated with a segment it is associated with the segment and a search is made for a further image point for the segment. Otherwise the segment is completed and a further not associated image point for a new segment is sought.

In step S14 a contour is then determined for each segment (see FIGS. 3 and 4). In this embodiment of the method of the invention a contour is given by a contour element or by a sequence of contour elements which include as data in each case two position coordinates in the X-Y-coordinate system. The concept of the sequence includes a succession of the contour elements or the sequence of the contour elements. For the determination of the contour the image points of a segment are first ordered in a series of increasing polar angle with respect to the Y-axis as polar axis, if this is necessary. Polar angles of image points with negative X-coordinates receive a negative sign so that during the movement from one edge of the detection region to the other edge of the detection region an increasing sequence of polar angles results. In the embodiment this association is not necessary when the detection sequence of the scan data elements is transferred into image points and their sequence is also not changed in the further course of the method.

The formation of a contour is for example shown by way of example in FIG. 4 for a segment which corresponds to a real object with a comparatively smooth contour. The contour elements are in this connection illustrated by squares which show which image points shown as crosses were associated with the contour element. For the formation of a contour element for a contour of a selected segment an image point 26 not yet associated with a contour element and having the smallest polar angle is selected and associated with the new contour element 30. Then sequential image points 28 and 28′ with increasing polar angle in sequence are associated with the contour element 30 until the distance to the first image point 26 associated with the contour element exceeds a predetermined value, which is for example selected in dependence on the resolution capability of the laser scanner 10. The first image point 32, which exceeds this predetermined spacing, is associated with a new contour element. Position coordinates of the contour element are then determined by average value formation from the image points associated with a contour element.

This process starts with the image point having the smallest polar angle so that in total a sequence of contour elements arises which is formed from image points in a sequence of increasing polar angle. In FIGS. 4 and 5 the position coordinates of a contour element correspond to the position of the centre of gravity of the squares represented by the contour elements, whereas the side length is intended to provide roughly and only qualitatively an impression of the maximum spacing of the image points used for the formation of the contour element. The line connecting the centre of gravity points only serves to illustrate a contour line defined by the contour elements.

As shown in FIG. 5 for an irregular real object, such as for example a bush, it can transpire that a contour element includes only a few image points and optionally also only one image point.

An object contour is associated in each cycle with each object and is likewise given by a contour element or by a sequence of contour elements. The formation of this object contour does not initially have any role to play, but will however be explained further at step S22.

In step S16, which could in principle also be executed prior to step S14 or parallel to it, a new object contour is predicted for each object of the preceding cycle, so far as the current cycle is not the first cycle, from an existing object contour. For this purpose the object speed determined in a preceding cycle is multiplied both in the X-direction but also in the Y-direction with the time duration between two sequential scans Δt, whereby a predicted object shift results. The predicted object contour now results from the fact that the position elements of the object contour are shifted by the predicted object shift. In this respect the form of the object contour is not changed but rather only its position. If an object has been newly formed in the preceding cycle then a suitable initial speed can be attributed to this object, for example an initial speed of zero. For objects with which no segments were associated in the preceding cycle a prediction is carried out over a correspondingly longer period of time which starts with the cycle after the last association of a segment to the object.

In the step S18 an association of the segments to the objects then takes place by comparison of the segment contours with the predicted object contours.

In order to accelerate the association, but not necessarily, rectangular segment boxes and object boxes are associated with segments in the object which have sides parallel to the coordinate axes. Whereas the segment box is the smallest rectangle that includes all image points of the segment in the current cycle (see the image points 33 in FIG. 5 for the segment box 34) the object box results from the fact that a smallest rectangle is also initially determined which includes the image points of the object in the preceding cycle, this rectangle is however enlarged if required in the X- and Y-directions differently by a constant value and the uncertainty of the object, determined by the uncertainty of the object speed. The object box is thus selected larger than the current outline detected in the preceding cycle so that this enlarged object box simultaneously includes a capture range in which a search for segments is made. This situation is shown in FIG. 6 in which contour elements 38 of a predicted object contour and contour elements 42 of a current object contour surrounded by a segment box 40 are located inside the object box 36.

For the pre-selection it is first checked whether, for a given segment, the segment box overlaps the object box of an object that is present.

Only when this is the case is the segment contour compared in the current cycle with the predicted object contour in that an association quality is determined in each case. For this purpose the number of pairs of contour elements of the segment contour and contour elements of the object contour is determined by calculation of all spacings between contour elements of the segment contour and contour elements of the predicted object contour for which the contour elements fall below a predetermined maximum segment/object association spacing. This maximum segment/object association spacing can for example be determined by optimization attempts for given object speeds and object sizes that are to be expected and which for example lie in a range from 1 to 2 m. In addition, the minimum spacing is also determined which occurs in the set of spacings of contour elements of all pairs. The number of contour element pairs lying closely alongside one another is then, for example, determined as the association quality, i.e. contour element pairs with a spacing smaller than the maximum segment/object association spacing divided by the sum of a constant and a minimum spacing of all pairs of contour elements. The constant is used amongst other things to avoid a division by zero and can be determined by optimization tests.

The segment is then associated with that object with which it has the highest association quality, that is to say for which the segment contour measured by the association quality is the most similar to the object contour. With an association quality of zero no association however is carried out.

In this manner each segment is first associated with at most one object, however a plurality of segments can be associated with one object.

In order to check an object decay a check is made in the association of two segments to one object whether the minimum spacing between the respective segment contour and the object contour, for example given by the minimum spacing of contour elements in the corresponding pairs of contour elements, falls below a predetermined threshold value which is for example selected in dependence on the object sizes to be expected. If this is the case the segment can be associated with the object, otherwise a separation takes place. Then the respectively largest segment, that is to say the segment with a segment contour with the most contour elements is associated with the object whereas the remaining segment is associated with an existing object.

In step S20 new objects are then formed from the segments which are not yet associated with existing objects.

In the step S22 a current contour is then formed for each object with which a segment was associated in the current cycle in that, taking account of the sequence of the contour elements, a sequence of contour elements is formed from the contour elements of the corresponding segments which results in a continuous contour. Furthermore, objects with which no segments were associated are maintained. The object contour in the preceding cycle is stored. In this connection, when the prediction exceeds a preset uncertainty, given by a maximum number of sequential cycles in which no segment was associated with the object contour, the corresponding objects are deleted. In another embodiment the uncertainty can also depend on the uncertainty or the estimated error of the speed.

In the step S24 a change of the object position by comparison with the object contour in the current cycle with the object contour in the preceding cycle is then found for each object which was not newly formed. The part steps which have to be carried out here are shown in FIG. 3 as part steps S24A to S24D to be carried out for each object already present in the preceding cycle. The association is illustrated further by way of example in FIG. 6.

For the calculation of the object movement the shifts of the contour elements 42 of the current object contour and of the predicted object contour, which was calculated in the already described manner from the object contour in the preceding cycle, are taken into account. In order to facilitate this association a correction shift is first determined in the step S24A. For this purpose reference elements are determined for the object contours which are characteristic for the object contours and thus simple to find again. A correction shift can then be found from the difference of the positions of the reference elements between the current object contour and the predicted object contour.

In the present example the first and last contour element of the respective object contour are in each case used as reference elements. In this connection a check is first made whether the respective first and last contour element of the predicted object contour and of the current object contour are hidden by foreground objects. The pair of the first or last contour elements of the current contour and of the predicted contour of which the contour elements are not hidden and of which the contour element of a current object contour lies closest to the laser scanner 10 was then used as a pair of reference elements. In FIG. 6 these are the left contour elements 44 and 44′ respectively. A correction shift vector is then calculated from the difference of the position coordinates.

If no reference elements are found, for example because at least two different first and last contour elements of the contours are hidden, the correction shift vector is set to the value zero, otherwise it results as a difference between the position coordinates of the reference element of the current object contour and the position coordinates of the corresponding reference element of the predicted contour. Furthermore, the value zero is associated with the correction shift vector if the magnitude of the correction shift is greater than a in dependence on the age of the object, given by the number of cycles during which the object already exists or if the contour elements—measured by the average mean square spacing from the reference element—are very strongly scattered.

In the step S24B the position coordinates of all contour elements of the predicted object contour are then shifted in accordance with the correction shift vector that has been found.

In the step S24C an association of contour elements 42 of the current object contour and the contour elements of the corrected predicted object contour then takes place. For this purpose, for each contour element of the corrected predicted object contour not yet associated with a contour element of the current object contour, that not yet associated contour element of the current object contour is sought which has a minimum spacing to the contour element of the corrected predicted object contour.

An association between two contour elements is only created, when this minimum spacing falls below a maximum spacing selected in dependence on the object speeds to be expected. If this is not the case the considered contour element is no longer used for the association in the further course of the method. In this manner a one-to-one association of the contour elements of the current object contour and a corrected predicted object contour is found, so far as possible.

In order to take account of the correction shift it is not explicitly necessary for a corrected predicted object contour to be formed, the correction shift can also be taken into account as the summand in the formulae which are used in the following method step, i.e. step S24C.

An object contour-object contour association quality is associated with an association of object contours to one another which is given in the embodiment by the number of pairs of mutually associated contour elements. For the just described association a first value of an object contour-object contour association quality is determined.

These steps are once again carried out without correction shift. The second value of the object contour-object contour association quality which then results is compared with the first value and the association with the value of the object contour-object contour association quality which is illustrated in FIG. 6 by the corresponding through-going lines between the contour elements 38 and 42 of the predicted object contour and the current object contour is then selected as the final association.

In the step S24D an object shift is then calculated from the pairs with contour elements associated with one another. In the embodiment the average value of the spacings in the X- and Y-direction of the coordinate elements and/or of the position coordinates of the corresponding contour elements is in each case found over all pairs. The result of this operation is a shift vector with components in the X- and Y-direction which is regarded as a shift vector for the object.

In the step S26 a (measured) momentary object speed is determined separately for the X-direction and the Y-direction from the shift vector taking account of the shift for the prediction and the time interval Δt of sequential scans of the scanned region.

These are subjected separately for each of the two directions to filtering with a one-dimensional Kalman filter for the object speed in the X-direction and the Y-direction. The corresponding momentary speeds serve as the measurement value and the corresponding current object speeds are the result. A value is selected as the uncertainty for the measurement, that is to say the variance for the measurement value or the monitoring speed, for example in dependence on the measurement accuracy of the laser scanner 10 and of the time spacing between two scans Δt. The system noise in the Kalman filter can be selected in dependence on the maximum object accelerations or acceleration changes to be expected. The algorithm for the one-dimensional Kalman filter is known to the person skilled in the art. The Kalman filter thus works as a low pass filter by means of which fluctuations in the detected object speeds can be suppressed.

The current object contour in the form of the contour elements and the current object speed can now be output to further data processing devices which can use these for example for a collision warning and optionally for corresponding control of the vehicle. For objects for which no segment was found a corresponding information can be output which can for example consist in the indication of an estimated error for the position and/or object speed. Parallel to the cycle a new current image is detected and after outputting the data a new image is read in a new cycle in the step S10.

Thus a very simple but accurate method results for object recognition and tracking in which changes of a detected contour of a real object can also be taken into account.

### REFERENCE NUMERAL LIST

10 laser scanner
12 motor vehicle
14 detection region
16 motor vehicle
18 motor vehicle
20 laser beam
22 real object point
24 electronic evaluation system
26 image point
28, 28′ image points
30 contour element
32 image point
33 image point
34 segment box
36 object box
38 contour elements
40 segment box
42 contour elements
44, 44′ reference elements

1.-28. (canceled)

29. Method for the recognition and tracking of objects on the basis of images of at least one real object (16, 18) including depth resolved image points (26, 28, 28′, 32, 33) detected in time sequence by at least one sensor (10) for an electromagnetic radiation, in particular a laser scanner, with the real object (16, 18) being in a detection range of the sensor (10), in which the following steps are carried out in sequential cycles:
at least one current object contour is formed from image points (26, 28, 28′, 32, 33) of a current image,
for objects in a preceding cycle at least one object contour is predicted in the current cycle starting in each case from an object contour associated with the respective object in the preceding cycle,
for at least one of the objects a current position is determined from the current object contour and/or an object speed is determined from the current object contour (42) and the object contour in a preceding cycle.

30. Method in accordance with claim 29,
characterized in that
for the formation of current object contours segments are formed from image points (26, 28, 28′, 32, 33) of a current image;
in that for each of the segments a segment contour (30) associated with the segment and its position are determined;
in that one of the segment contours is compared with at least one of the predicted object contours with reference to the position and/or the shape and in dependence of the result of a comparison the segment corresponding to the segment contour is associated with one of the objects and in that current object contours (42) are respectively formed from the segments respectively associated with the segment contours of objects.

31. Method in accordance with claim 29,
in that contours are defined by a contour element or by a sequence of contour elements (30, 38, 42) and in that the contour element or data defining the contour elements (30, 38, 42) are determined from at least one image point (26, 28, 28′, 32, 33) of a segment or contour elements of another contour.

32. Method in accordance with claim 31,
characterized in that
the contour elements (30, 38, 42) respectively include position coordinates as data.

33. Method in accordance with claim 31,
characterized in that
for the formation of a contour element (30) of a segment contour a predetermined number of sequential image points (26, 28, 28′, 32, 33) of the segment with polar angles which increase or reduce in a series with respect to a predetermined polar axis are associated with a corresponding contour element and in that data of the contour element is determined from the image point (26, 28, 28′, 32, 32).

34. Method in accordance with claim 31,
characterized in that
for the formation of a contour element (30, 38, 42) of a segment contour respective sequential image points (26, 28, 28′, 32, 33) of the segment in a series of increasing or decreasing polar angle with respect to a predetermined polar axis are associated with a corresponding contour element the spacing of which from a first image point (26) associated with the contour element is smaller than a predetermined maximum spacing and in that data of the contour element are determined from these image points (26, 28, 28′, 32, 33).

35. Method in accordance with claim 31,
characterized in that
contour elements are obtained by vectorization of a curve which arises by connecting the image points (26, 28, 28′, 32, 33) of a segment in a series of increasing or decreasing polar angle with reference to a predetermined polar axis.

36. Method in accordance with claim 31,
characterized in that
the positions of the image points (26, 28, 28′, 32, 33) of a segment are subjected to low pass filtering prior to the formation of the contour elements.

37. Method in accordance with claim 31,
characterized in that
a quality is associated with at least one contour element which depends on the position of the image points (26, 28, 28′, 32, 33) used for the determination of the contour element.

38. Method in accordance with claim 29,
characterized in that,
for the prediction of the position of an object contour in a current cycle, an object speed determined in a preceding cycle is used.

39. Method in accordance with claim 29,
characterized in that
a capture region is associated with each object and in that a segment contour of a segment is only compared with an object contour of an object in the capture region of which at least one reference point of the respective segment lies.

40. Method in accordance with claim 29,
characterized in that,
for the comparison of a segment contour with an object contour, an association quality is determined for a segment and an object which is a measure for the agreement of the respective contours with respect to position and/or shape and in that a segment which can be associated with two objects is associated with that object for which it has the best value of the association quality.

41. Method in accordance with claim 31,
characterized in that,
for the comparison of a segment contour with an object contour, an association quality is determined for a segment and an object which is a measure for the agreement of the respective contours with respect to position and/or shape and in that a segment which can be associated with two objects is associated with that object for which it has the best value of the association quality;
and in that from pairs respectively consisting of a contour element of the segment contour and a contour element of the object contour, differences are determined between corresponding data of the contour elements and in that the association quality is determined using the differences.

42. Method in accordance with claim 31,
characterized in that,
for the comparison of a segment contour with an object contour, an association quality is determined for a segment and an object which is a measure for the agreement of the respective contours with respect to position and/or shape and in that a segment which can be associated with two objects is associated with that object for which it has the best value of the association quality;
and in that pairs respectively consisting of a contour element of the segment contour and a contour element of the object contour are determined among the contour elements of the segment contour and the contour elements of the object contour which at most differ in one item of the data by a predetermined amount and in that the number of these pairs is determined for the determination of the association quality.

43. Method in accordance with claim 31,
characterized in that
for the comparison of a segment contour with an object contour, an association quality is determined for a segment and an object which is a measure for the agreement of the respective contours with respect to position and/or shape and in that a segment which can be associated with two objects is associated with that object for which it has the best value of the association quality;
and in that pairs respectively consisting of a contour element of the segment contour and a contour element of the object contour are determined among the contour elements of the segment contour and contour elements of the object contour for which position coordinates have a spacing which is smaller than a predetermined maximum pair spacing and in that the number of these pairs is determined for the determination of the association quality.

44. Method in accordance with claim 31,
characterized in that
for the comparison of a segment contour with an object contour, an association quality is determined for a segment and an object which is a measure for the agreement of the respective contours with respect to position and/or shape and in that a segment which can be associated with two objects is associated with that object for which it has the best value of the association quality;
and in that for the determination of the association quality a contour element of the segment contour and a contour element of the object contour are determined for which the position coordinates have the smallest spacing among all pairs of contour elements of the segment contour and contour elements of the object contour.

45. Method in accordance with claim 29,
characterized in that
two or more segments are only then associated with an object when a spacing of the segments from the object is respectively smaller than a predetermined maximum spacing.

46. Method in accordance with claim 29,
characterized in that
a hiding recognition is executed during the association of segments to objects.

47. Method in accordance claim 29,
characterized in that
when recognizing at least two segments which can be associated with the same object, but which should not both be associated with the same object, the segment with the better association quality is associated with the object.

48. Method in accordance with claim 29,
characterized in that
for the determination of the object speed a difference is determined between the position and/or the orientation of the current object contour and the position and/or orientation of the object contour in the preceding cycle or the predicted object contour.

49. Method in accordance with claim 31,
characterized in that
in the determination of the difference between the position and/or orientation of the object in the current cycle and the position and/or orientation of the object contour in the preceding cycle, or the predicted object contour, contour elements (42) of the current object contour and contour elements (38) of the object contour in the preceding cycle or of the predicted contour are associated with one another and in that the change of the position and/or orientation of the object contour in the preceding cycle to that in the current cycle is determined from those contour elements (42) of the current contour which are associated with contour elements (38) of the object contour in the preceding cycle or of the predicted object contour.

50. Method in accordance with claim 31,
characterized in that
for the association of contour elements (38, 42) of two object contours relative to one another, starting from contour elements (44, 44′) of the object contours with position coordinates which respectively correspond to one end of the contour, a search is in each case made, for sequential contour elements along one of the two contours, for a corresponding not yet associated contour element of the other contour of which the position coordinates have a minimum spacing from the position coordinates of the contour element of the one contour.

51. Method in accordance with claim 31,
characterized in that
in each case at least one reference element (44, 44′) is determined for an object contour (38, 42); in that, for the association of object elements (38) of the predicted contour and object elements (42) of the current object contour, a correction shift is found between the reference elements (44, 44′) of the predicted contour and the current contour and in that the association of contour elements of the predicted contour to contour elements of the current contour takes place using the contour elements of the predicted contour shifted by the correction shift of the reference elements.

52. Method in accordance with claim 31,
characterized in that
differences between the position coordinates of mutually associated contour elements (42; 38) of the current contour and of the contour determined in the preceding cycle or of the predicted contour are first determined; in that a translation and/or a rotation of the object between the preceding cycle and the current cycle is determined from these differences and in that the object speed is determined on the basis of this translation and/or rotation.

53. Method in accordance with claim 29,
characterized in that
the object speeds are subjected to a low pass filtering operation.

54. Computer program having program code means for carrying out a method for the recognition and tracking of objects on the basis of images of at least one real object (16, 18) including depth resolved image points (26, 28, 28′, 32, 33) detected in time sequence by at least one sensor (10) for an electromagnetic radiation, in particular a laser scanner, with the real object (16, 18) being in a detection range of the sensor (10), in which the following steps are carried out in sequential cycles:
at least one current object contour is formed from image points (26, 28, 28′, 32, 33) of a current image,
for objects in a preceding cycle at least one object contour is predicted in the current cycle starting in each case from an object contour associated with the respective object in the preceding cycle,
for at least one of the objects a current position is determined from the current object contour and/or an object speed is determined from the current object contour (42) and the object contour in a preceding cycle, said program being executed on a computer (24).

55. Computer program product with program code means which are stored on a computer readable data carrier in order to carry out the method for the recognition and tracking of objects on the basis of images of at least one real object (16, 18) including depth resolved image points (26, 28, 28′, 32, 33) detected in time sequence by at least one sensor (10) for an electromagnetic radiation, in particular a laser scanner, with the real object (16, 18) being in a detection range of the sensor (10), in which the following steps are carried out in sequential cycles:
at least one current object contour is formed from image points (26, 28, 28′, 32, 33) of a current image,
for objects in a preceding cycle at least one object contour is predicted in the current cycle starting in each case from an object contour associated with the respective object in the preceding cycle,
for at least one of the objects a current position is determined from the current object contour and/or an object speed is determined from the current object contour (42) and the object contour in a preceding cycle said computer program product being executed on a computer (24).

56. Apparatus for the recognition and tracking of objects with at least one optoelectronic sensor (10), in particular a laser scanner, the viewing range of which includes the detection range (14) and
a data processing device (24) associated with the optoelectronic sensor (19), said data processing device being designed to carry out a method for the recognition and tracking of objects on the basis of images of at least one real object (16, 18) including depth resolved image points (26, 28, 28′, 32, 33) detected in time sequence by at least one sensor (10) for an electromagnetic radiation, in particular a laser scanner, with the real object (16, 18) being in a detection range of the sensor (10), in which the following steps are carried out in sequential cycles:
at least one current object contour is formed from image points (26, 28, 28′, 32, 33) of a current image,
for objects in a preceding cycle at least one object contour is predicted in the current cycle starting in each case from an object contour associated with the respective object in the preceding cycle,
for at least one of the objects a current position is determined from the current object contour and/or an object speed is determined from the current object contour (42) and the object contour in a preceding cycle.
